(19) United States
(12) Patent Application Publication
(10) Pub. No.: US 2025/0370476 A1
(43) Pub. Date: Dec. 4, 2025

(54) METHODS AND APPARATUS FOR OBJECT QUALITY DETECTION

(71) Applicant: Boston Dynamics, Inc., Waltham, MA (US)

(72) Inventors: Alexander Broad, Somerville, MA (US); Arash Ushani, Cambridge, MA (US); Karthik Ramachandran, Sunnyvale, CA (US); Amy Blank, Watertown, MA (US); Krista Shapton, Malden, MA (US); Scott Gilroy, Waltham, MA (US); Maurice Rahme, Cambridge, MA (US); Samuel Shaw, Somerville, MA (US); Grant Aylward, Somerville, MA (US); Michael Murphy, Carlisle, MA (US); Alexander Perkins, Lincoln, MA (US)

(21) Appl. No.: 18/679,613

(22) Filed: May 31, 2024

(51) Int. Cl. G05D 1/656; G05D 1/646; G05D 1/65; G05D 101/15; G05D 107/70; G05D 111/10; G06T 7/00; G06V 10/70; G06V 10/98; G06V 20/56

(52) U.S. Cl. CPC G05D 1/656; G05D 1/646; G05D 1/65; G06T 7/0004; G06V 10/70; G06V 10/993; G06V 20/56; G05D 2101/15; G05D 2107/70; G05D 2111/10; G06T 2207/20081; G06T 2207/30168

(57) ABSTRACT

Methods and apparatus for assigning a quality metric to an object to be grasped by a mobile robot are provided. The method includes receiving at least one image including a set of objects, processing the at least one image using a trained machine learning model to assign a quality metric to a first object of the set of objects in the at least one image, and controlling the mobile robot to perform an action based, at least in part, on the quality metric assigned to the first object.

### BACKGROUND

A robot is generally defined as a reprogrammable and multifunctional manipulator designed to move material, parts, tools, or specialized devices through variable programmed motions for a performance of tasks. Robots may be manipulators that are physically anchored (e.g., industrial robotic arms), mobile robots that move throughout an environment (e.g., using legs, wheels, or traction-based mechanisms), or some combination of a manipulator and a mobile robot. Robots are utilized in a variety of industries including, for example, manufacturing, warehouse logistics, transportation, hazardous environments, exploration, and healthcare.

### SUMMARY

Robots are typically configured to perform various tasks in an environment in which they are placed. Generally, these tasks include interacting with objects and/or the elements of the environment. Notably, robots are becoming popular in warehouse and logistics operations. Before the introduction of robots to such spaces, many operations were performed manually. For example, a person might manually unload boxes from a truck onto one end of a conveyor belt, and a second person at the opposite end of the conveyor belt might organize those boxes onto a pallet. The pallet may then be picked up by a forklift operated by a third person, who might drive to a storage area of the warehouse and drop the pallet for a fourth person to remove the individual boxes from the pallet and place them on shelves in the storage area. More recently, robotic solutions have been developed to automate many of these functions.

The quality (e.g., the structural integrity) of objects to be grasped by a mobile robot may impact performance indicators (e.g., case handling rate, intervention rate, etc.) for mobile robots in efficiently performing tasks (e.g., truck unloading, pallet building, etc.). For example, quality information (e.g., wear, damage, etc.) associated with an object may be used to improve object movement strategies, product signals to downstream processing systems, or trigger human assistance. As described herein, some embodiments of the present disclosure relate to techniques for automatically assessing the quality of objects (e.g., boxes, cases, parcels, etc.) to be grasped and moved by a mobile robot and using the quality information to modify the behavior of the robot when manipulating the object.

In some embodiments, the invention features a method. The method includes receiving, by a processor of a mobile robot, at least one image including a set of objects, processing the at least one image using a trained machine learning model to assign a quality metric to a first object of the set of objects in the at least one image, and controlling the mobile robot to perform an action based, at least in part, on the quality metric assigned to the first object.

In one aspect, the set of objects includes a set of boxes, the trained machine learning model includes a box detection model, and processing the at least one image to assign a quality metric to a first object of the set of objects comprises processing the at least one image using the box detection model. In another aspect, the box detection model is configured to detect two dimensional box faces. In another aspect, the box detection model is configured to detect three dimensional shapes.

In another aspect, processing the at least one image to assign a quality metric to a first object of the set of objects comprises determining an extent of damage to the first object and assigning the quality metric based on the extent of damage to the first object. In another aspect, determining an extent of damage to the first object comprises categorizing the extent of damage into two or more categories of damage. In another aspect, the two or more categories of damage include worn, crushed or destroyed.

In another aspect, controlling the mobile robot to perform an action comprises controlling the mobile robot to provide an indication to a user that the first object cannot be effectively grasped by the mobile robot when the quality metric is less than a threshold value. In another aspect, controlling the mobile robot to perform an action comprises selecting, based on the quality metric associated with the first object, a grasping strategy for grasping the first object, and controlling the mobile robot to grasp the first object based on the grasping strategy. In another aspect, selecting a grasping strategy for grasping the first object comprises selecting a second face of the first object to grasp when the quality metric assigned to the first object indicates that a first face of the first object has a quality less than a threshold value, and controlling the mobile robot to grasp the first object based on the grasping strategy comprises controlling the mobile robot to grasp the second face of the first object. In another aspect, the first face is a front face of the first object and the second face is a top face or a side face of the first object. In another aspect, selecting a grasping strategy for grasping the first object comprises selecting one or more locations on the first object to grasp the first object, and controlling the mobile robot to grasp the first object based on the grasping strategy comprises controlling the mobile robot to grasp the first object at the one or more locations. In another aspect, selecting a grasping strategy for grasping the first object comprises selecting a grasping technique based on the quality metric assigned to the first object, and controlling the mobile robot to grasp the first object based on the grasping strategy comprises controlling the mobile robot to grasp the first object using the grasping technique. In another aspect, selecting the grasping technique comprises selecting a pinch grasp technique when the quality metric assigned to the first object is less than a threshold value.

In another aspect, controlling the mobile robot to perform an action comprises determining an order of grasping objects from the set of objects based, at least in part, on the quality metric. In another aspect, determining an order of grasping objects from the set of objects comprises determining to grasp a second object of the set of objects prior to grasping the first object when the quality metric assigned to the first object is less than a threshold value. In another aspect, determining an order of grasping objects from the set of objects comprises determining to grasp the first object first when the quality metric assigned to the first object is less than a threshold value.

In another aspect, controlling the mobile robot to perform an action comprises controlling the mobile robot to move the first object from a first location to a second location at a speed determined based, at least in part, on the quality metric. In another aspect, controlling the mobile robot to perform an action comprises controlling the mobile robot to move the first object from a first location to a second location through a trajectory determined based, at least in part, on the quality metric. In another aspect, the method further includes determining, a parametric shape and dynamics of the trajectory based, at least part, on the quality metric.

In another aspect, controlling the mobile robot to perform an action comprises controlling the mobile robot to grasp the first object, and the method further includes detecting a change in an estimated mass of the first object while grasping the first object, selecting an image including the first object captured prior to grasping the first object, receiving an annotated version of the image, and retraining the trained machine learning model using the annotated version of the image.

In some embodiments, the invention features a mobile robot. The mobile robot includes a processor configured to receive at least one image including a set of objects, and process the at least one image using a trained machine learning model to assign a quality metric to a first object of the set of objects in the at least one image. The mobile robot further includes a controller configured to control the mobile robot to perform an action based, at least in part, on the quality metric assigned to the first object.

In one aspect, the set of objects includes a set of boxes, the trained machine learning model includes a box detection model, and the processor is configured to process the at least one image to assign a quality metric to a first object of the set of objects by processing the at least one image using the box detection model. In another aspect, the processor is configured to process the at least one image to assign a quality metric to a first object of the set of objects by determining an extent of damage to the first object, and assigning the quality metric based on the extent of damage to the first object. In another aspect, determining an extent of damage to the first object comprises categorizing the extent of damage into two or more categories of damage. In another aspect, the two or more categories of damage include worn, crushed or destroyed.

In another aspect, the controller is configured to control the mobile robot to perform an action by controlling the mobile robot to provide an indication to a user that the first object cannot be effectively grasped by the mobile robot when the quality metric is less than a threshold value. In another aspect, the mobile robot further includes at least one end effector, and the controller is configured to control the mobile robot to perform an action by selecting, based on the quality metric associated with the first object, a grasping strategy for grasping the first object with the at least one end effector, and controlling the mobile robot to grasp the first object with the at least one end effector based on the grasping strategy. In another aspect, selecting a grasping strategy for grasping the first object with the at least one end effector comprises selecting a second face of the first object to grasp when the quality metric assigned to the first object indicates that a first face of the first object has a quality less than a threshold value, and the controller is configured to control the mobile robot to grasp the first object with the at least one end effector based on the grasping strategy by controlling the mobile robot to grasp the second face of the first object. In another aspect, the first face is a front face of the first object and the second face is a top face or a side face of the first object. In another aspect, selecting a grasping strategy for grasping the first object with the at least one end effector comprises selecting one or more locations on the first object to grasp the first object, and the controller is configured to control the mobile robot to grasp the first object with the at least one end effector based on the grasping strategy by controlling the mobile robot to grasp the first object at the one or more locations. In another aspect, selecting a grasping strategy for grasping the first object with the at least one end effector comprises selecting a grasping technique based on the quality metric assigned to the first object, and the controller is configured to control the mobile robot to grasp the first object with the at least one end effector based on the grasping strategy by controlling the mobile robot to grasp the first object using the grasping technique. In another aspect, selecting the grasping technique comprises selecting a pinch grasp technique when the quality metric assigned to the first object is less than a threshold value.

In another aspect, the controller is configured to control the mobile robot to perform an action by determining an order of grasping objects from the set of objects based, at least in part, on the quality metric. In another aspect, determining an order of grasping objects from the set of objects comprises determining to grasp a second object of the set of objects prior to grasping the first object when the quality metric assigned to the first object is less than a threshold value. In another aspect, determining an order of grasping objects from the set of objects comprises determining to grasp the first object first when the quality metric assigned to the first object is less than a threshold value. In another aspect, the controller is configured to control the mobile robot to perform an action by controlling the mobile robot to move the first object from a first location to a second location at a speed determined based, at least in part, on the quality metric. In another aspect, the controller is configured to control the mobile robot to perform an action by controlling the mobile robot to move the first object from a first location to a second location through a trajectory determined based, at least in part, on the quality metric. In another aspect, the processor is further configured to determine, a parametric shape and dynamics of the trajectory based, at least part, on the quality metric.

In another aspect, the controller is configured to control the mobile robot to perform an action by controlling the mobile robot to grasp the first object, and the processor is further configured to detect a change in an estimated mass of the first object while grasping the first object, select an image including the first object captured prior to grasping the first object, receive an annotated version of the image, and retrain the trained machine learning model using the annotated version of the image.

In some embodiments, the invention features a method. The method includes detecting, after grasping an object by mobile robot, a change in an estimated mass of the object, determining an image including the object to annotate in response to detecting the change in the estimated mass of the object, receiving an annotated version of the image, the image including an annotation that the object has a poor quality, and training a machine learning model based, at least in part, on the annotated version of the image.

In one aspect, detecting a change in an estimated mass of the object comprises receiving from at least one force and/or torque sensor arranged on an end effector of the mobile robot, a signal from which a mass of the object can be determined. In another aspect, detecting a change in an estimated mass of the object further comprises monitoring the signal to determine whether a value of the signal has deviated from a baseline level by at least a threshold amount, and detecting a change in the estimated mass of the object when it is determined that the value of the signal has deviated from the baseline level by at least the threshold amount. In another aspect, determining an image including the object to annotate in response to detecting the change in the estimated mass of the object comprises selecting an image captured prior to the mobile robot grasping the object.

In some embodiments, the invention features a method. The method includes receiving a set of images, each image in the set of images including a set of objects, processing the set of images using a trained machine learning model to detect one or more damaged objects, and generating a report indicating a total number of damaged objects detected in the set of images.

In one aspect, generating the report comprises including in the report at least one annotated image from the set of images, the at least one annotated image showing an indication of at least one damaged object present in the at least one annotated image. In another aspect, the method further includes transmitting information associated with the detected one or more damaged objects from a mobile robot configured to capture the set of images to a downstream apparatus in a warehouse. In another aspect, the downstream apparatus is an object sorting apparatus.

In some embodiments, the invention features a non-transitory computer readable medium including a plurality of processor executable instructions stored thereon that, when executed by a processor, perform any of the methods described herein.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIGS. 1A and 1B are perspective views of a robot, according to an illustrative embodiment of the invention.

FIG. 2A depicts robots performing different tasks within a warehouse environment, according to an illustrative embodiment of the invention.

FIG. 2B depicts a robot unloading boxes from a truck and placing them on a conveyor belt, according to an illustrative embodiment of the invention.

FIG. 2C depicts a robot performing an order building task in which the robot places boxes onto a pallet, according to an illustrative embodiment of the invention.

FIG. 3 is a flowchart of a process for determining a quality metric for an object, according to an illustrative embodiment of the invention.

FIGS. 4A-4C illustrate boxes having different qualities which may be determined using one or more of the techniques described herein, according to illustrative embodiments of the invention.

FIG. 5 is a flowchart of a process for determining training data for a machine learning model, according to an illustrative embodiment of the invention.

FIG. 6 is an example plot shown a monitored estimated mass of an object grasped by a mobile robot, according to an illustrative embodiment of the invention.

FIG. 7 is a flowchart of a process for generating a report of damaged objects identified using one or more of the techniques described herein, according to an illustrative embodiment of the invention.

FIG. 8 shows an example report generated according to an illustrative embodiment of the invention.

FIG. 9 shows an example image that may be included in an example report generated according to an illustrative embodiment of the invention.

FIG. 10 illustrates an example configuration of a robotic device, according to an illustrative embodiment of the invention.

### DETAILED DESCRIPTION

The speed at which a mobile robot can operate to perform a task such as unloading boxes from a truck or building a pallet of boxes is an important consideration when determining whether to use robots to perform such tasks. Although a robot may be expected to perform relatively well when interacting with boxes that are in good condition, interacting with boxes in degraded, damaged, or worse condition may be challenging for a robot. When a mobile robot encounters a damaged object, a human user may be needed to manually interact with the object (e.g., by carefully removing it from a stack of objects), resulting in downtime for the robot, thereby lowering its case handling throughput. The downtime may be particularly lengthy if, for example, the robot attempts to grasp and move a damaged object (e.g., a damaged box), the integrity of the object is further breached as a result of the interaction, and the contents of the object spill onto the floor. In such an instance, operation of the robot may be ceased until a human worker can clear the spilled contents from floor of the work area.

Human workers tasked with interacting with boxes in a warehouse may be able to recognize quality issues with a box prior to grasping it, and may take appropriate action (e.g., grasping it carefully, placing a hand underneath the box, etc.) when the perceived box quality is poor. By contrast, mobile robots tasked with interacting with objects (e.g., boxes) typically do not take object quality into account when attempting to grasp an object, which may result in poor quality grasps, contents of the box spilling, and/or other undesirable consequences that may slow down normal operation of the mobile robot. The inventors have recognized and appreciated that by assessing the quality of a box or other object to be grasped by a mobile robot prior to grasping the object, a mobile robot may be able to appropriately plan one or more actions on how to interact with the object. For instance, the mobile robot may determine not to interact with the object when it is too damaged, interact with the object carefully (e.g., by grasping a particular face that has less damage, by moving the object slowly through a trajectory) when the object is slightly damaged, or interact with the object normally or with fewer restrictions when the object has minimal or no visible damage. To this end, some embodiments relate to techniques for determining a quality metric associated with one or more objects to be grasped by a mobile robot and using the quality metric to influence how the mobile robot interact with the object(s).

Robots configured to operate in a warehouse or industrial environment are typically either be specialist robots (i.e., designed to perform a single task or a small number of related tasks) or generalist robots (i.e., designed to perform a wide variety of tasks). To date, both specialist and generalist warehouse robots have been associated with significant limitations.

For example, because a specialist robot may be designed to perform a single task (e.g., unloading boxes from a truck onto a conveyor belt), while such specialized robots may be efficient at performing their designated task, they may be unable to perform other related tasks. As a result, either a person or a separate robot (e.g., another specialist robot designed for a different task) may be needed to perform the next task(s) in the sequence. As such, a warehouse may need to invest in multiple specialized robots to perform a sequence of tasks, or may need to rely on a hybrid operation in which there are frequent robot-to-human or human-to-robot handoffs of objects.

In contrast, while a generalist robot may be designed to perform a wide variety of tasks (e.g., unloading, palletizing, transporting, depalletizing, and/or storing), such generalist robots may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible.

Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task.

In such systems, the mobile base and the manipulator may be regarded as effectively two separate robots that have been joined together. Accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while certain limitations arise from an engineering perspective, additional limitations must be imposed to comply with safety regulations. For example, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not threaten the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, a highly integrated mobile manipulator robot with system-level mechanical design and holistic control strategies between the manipulator and the mobile base may provide certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

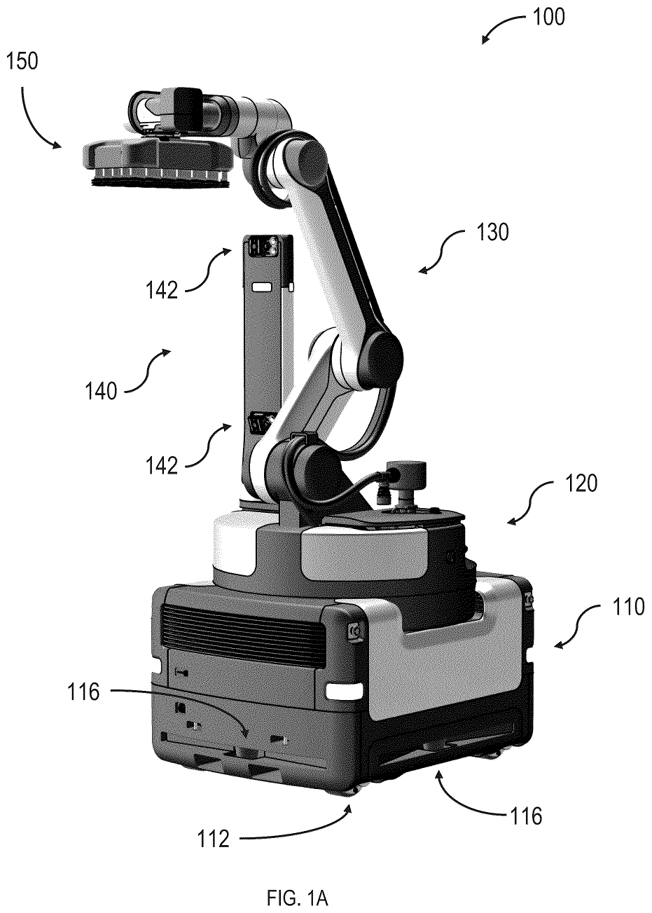

FIGS. 1A and 1B are perspective views of a robot 100, according to an illustrative embodiment of the invention. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

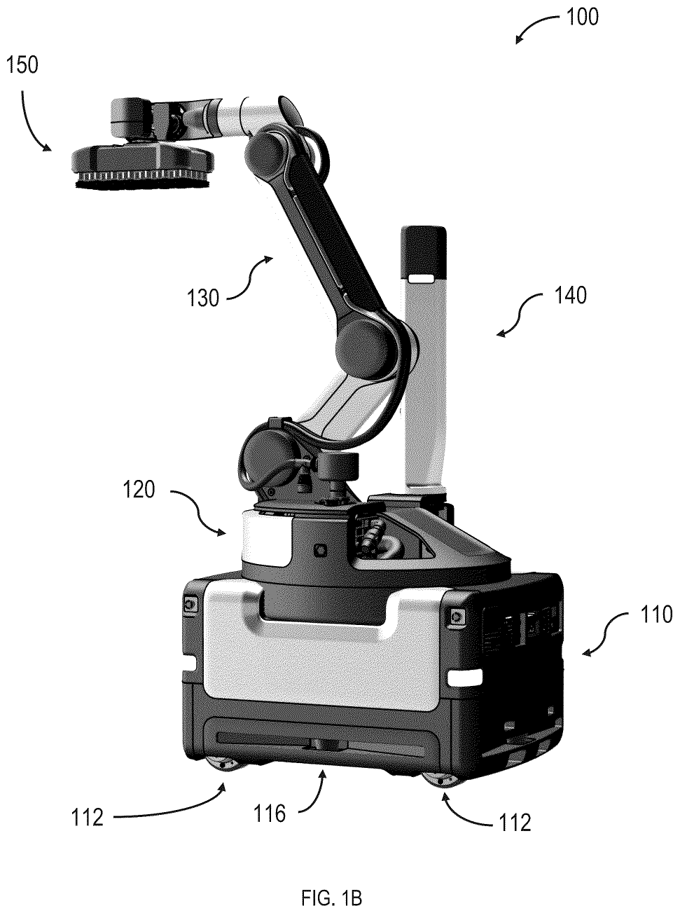

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). The robots 10a, 10b, and 10c can be different instances of the same robot or similar robots. Accordingly, the robots described herein may be understood as specialized multi-purpose robots, in that they are designed to perform specific tasks accurately and efficiently, but are not limited to only one or a small number of tasks.

FIG. 2B depicts a robot 20a unloading boxes 21 from a truck 29 and placing them on a conveyor belt 22. In this box picking application (as well as in other box picking applications), the robot 20a repetitiously picks a box, rotates, places the box, and rotates back to pick the next box. Although robot 20a of FIG. 2B is a different embodiment from robot 100 of FIGS. 1A and 1B, referring to the components of robot 100 identified in FIGS. 1A and 1B will ease explanation of the operation of the robot 20a in FIG. 2B.

During operation, the perception mast of robot 20a (analogous to the perception mast 140 of robot 100 of FIGS. 1A and 1B) may be configured to rotate independently of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety field around the robot (e.g., into which humans are prevented from entering and/or which are associated with other safety controls, as explained in greater detail below).

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

The tasks depicted in FIGS. 2A-2C are only a few examples of applications in which an integrated mobile manipulator robot may be used, and the present disclosure is not limited to robots configured to perform only these specific tasks. For example, the robots described herein may be suited to perform tasks including, but not limited to: removing objects from a truck or container; placing objects on a conveyor belt; removing objects from a conveyor belt; organizing objects into a stack; organizing objects on a pallet; placing objects on a shelf; organizing objects on a shelf; removing objects from a shelf; picking objects from the top (e.g., performing a “top pick”); picking objects from a side (e.g., performing a “face pick”); coordinating with other mobile manipulator robots; coordinating with other warehouse robots (e.g., coordinating with AMRs); coordinating with humans; and many other tasks.

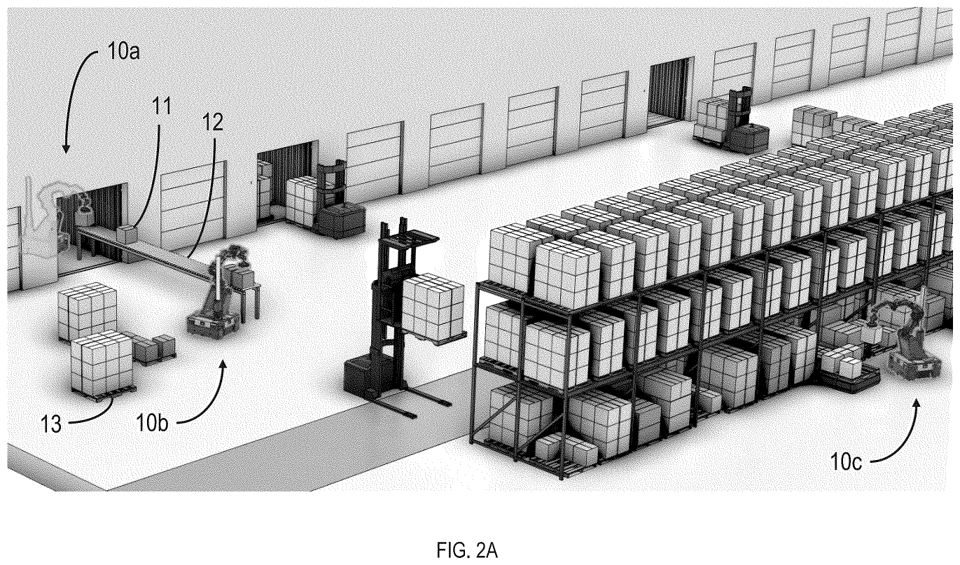

As discussed above, detecting a damaged object prior to controlling a mobile robot to interact with (e.g., pick and place) the object may help ensure that the mobile robot interacts with the object in an appropriate manner to, for example, reduce downtime of the robot that may be caused by improper handling of damaged objects. FIG. 3 is a flowchart of a process 300 for controlling a mobile robot based on a quality metric associated with an object, in accordance with some embodiments of the present disclosure. Process 300 begins in act 310, where at least one image including a set of objects (e.g., one or more objects) is received by a processor associated with a mobile robot. For instance, the mobile robot may include an onboard sensor system (e.g., one or more cameras) configured to capture an image of a stack of boxes arranged within a truck. The mobile robot may be tasked with unloading the boxes from the truck onto a conveyor, and may process the captured images to determine how to pick and place the boxes from the stack of boxes onto the conveyor. Process 300 then proceeds to act 312, where the at least one image is processed using a machine learning model trained to assign a quality metric to a first object in the set of objects included in the at least one image. In some embodiments, the trained machine learning model may be configured to detect two-dimensional shapes (e.g. box faces). In some embodiments, the trained machine learning model may be configured to detect three-dimensional shapes (e.g., boxes). In some embodiments, the trained machine learning model may be a box detection model configured to identify one or more faces of boxes in an image. The trained machine learning model may be configured to output a representation that includes descriptions of the box face(s) in the image. In addition to detecting box faces, the box detection model or another trained machine learning model used in combination with the box detection model may be configured to assess the quality of one or more boxes (or box faces) in the set of boxes and assign a quality metric to each of boxes for which quality has been assessed.

Assigning a quality metric to an object in a set of objects using a machine learning model may be performed in any suitable way. For instance, the machine learning model may be trained on a set of images having object quality metrics assigned by a human operator to one or more of the objects in the set. In this way, the machine learning model may learn how to distinguish “good quality” objects from “poor quality” objects in new images during operation of the mobile robot. In some embodiments, the machine learning model may be configured to assign a quality metric to all identified objects (e.g., all box faces) in an image. In some embodiments, determining a quality metric includes determining a confidence value associated with the quality metric. For instance, the output of the machine learning model may be a quality metric (e.g., good quality, poor quality) and a confidence value may be associated with the assigned quality metric based on how confident the model is in the assigned quality metric. In embodiments that include a confidence value, the confidence value may be used to determine a particular action to perform when interacting with a particular object. For instance, if the object is a assigned a poor quality metric with high confidence, it may be determined that the object is damaged and should not be grasped by the mobile robot. Alternatively, if the object is assigned a good quality metric with low confidence, the mobile robot may be controlled to interact with the object carefully due to the low confidence value associated with the object.

In some embodiments, the quality metric output from the trained machine learning model may be determined based on classifying an extent of damage to the object. In some instances, the quality metric output from the machine learning model may be a binary value (e.g., good quality or poor quality). In some instances, the quality metric output from the machine learning model may take more than two values, with each value representing a different extent and/or type of damage (e.g., good, worn, crushed, destroyed) associated with the object being classified. In some instances, the quality metric output from the machine learning model may be a continuous variable (e.g., a numerical score) associated with a quality of the object being classified. On one hand, it should be appreciated that having a larger number of quality metric classifications may enable the mobile robot to interact with the object in more varied ways than if a binary quality metric classification is used. On the other hand, it should be appreciated that training a model to output a larger number of quality metric classifications may require substantially more training data to enable the trained machine learning model to accurately predict the different quality metric classifications.

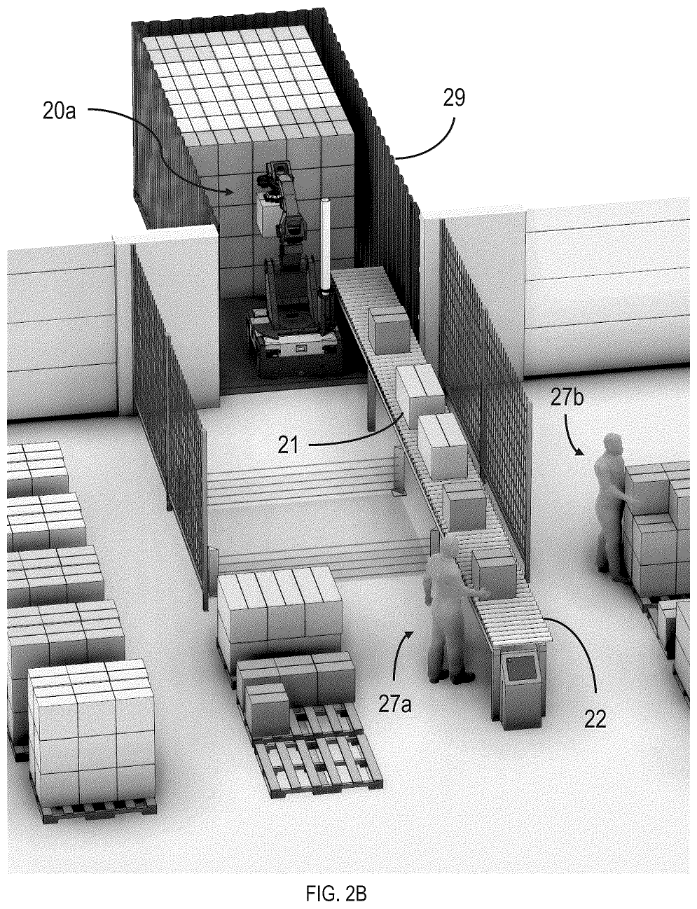

FIGS. 4A-4C illustrate examples of boxes to which different quality metrics may be assigned based on perceived extents of damage, in accordance with some embodiments of the present disclosure. FIG. 4A shows a box having good quality, in which the observable faces of the box appear to be intact such that they can be effectively grasped by a mobile robot. FIG. 4B shows a box having a minor extent of damage. As can be observed, some faces of the box shown in FIG. 4B appear worn with small creases and/or bulges. FIG. 4C shows a box having more substantial damage than the box shown in FIG. 4B. For instance, the box shown in FIG. 4C appears to have been crushed with some of the box faces being deformed substantially compared, for example, to the boxes shown in FIGS. 4A and 4B. Despite being damaged, the boxes shown in FIG. 4B and 4C may be capable of being grasped and moved effectively by a mobile robot. However, as described in further detail below, the manner in which the mobile robot may be configured to interact with object having damage may differ depending on the extent of damage to the object as reflected in its assigned quality metric using one or more of the techniques described herein. Although not shown, the quality of some objects may be of such poor quality (e.g., they may be “destroyed”) such that they may not be capable of being grasped and/or moved effectively by a mobile robot. For example, if the face of a box includes a large tear that compromises the integrity of the box, it may be determined that such a box has poor quality, and the mobile robot may be configured to interact with such objects differently than objects such as those shown in FIGS. 4B and 4C that are damaged to some extent, but can still be grasped and moved by the mobile robot.

Returning to process 300, after the at least one image has been processed using a trained machine learning model in act 312, process 300 proceeds to act 314, where the mobile robot is controlled to perform an action based, at least in part, on the quality metric assigned to a first object in the set of objects. In some embodiments, the action to be performed by the mobile robot may include grasping and moving the first object with few or no limitations when quality metric assigned to the first object indicates that the first object has good quality.

In some instances, the quality metric assigned in act 312 may indicate that the first object (e.g., a face of the first object) is sufficiently damaged that it cannot be effectively grasped and/or moved by the mobile robot. In such instances, the action to be performed by the mobile robot in act 314 may include instructing a user (e.g., a human) that the first object is damaged and manual intervention is required. After providing the instruction, the mobile robot may shut down its normal operation to allow the user to manually move the damaged object prior to restarting the normal operation of the robot. Requiring manual intervention by a human user when an object is determined to have a poor quality may significantly slow down the case handling rate of the mobile robot. In some instances, when the quality metric associated with the first object indicates that the first object has poor quality (and thus may not be moved effectively by the gripper of the mobile robot), the mobile robot may perform an action that does not require immediate manual intervention by a user of the mobile robot. For example, the mobile robot may be configured to “pick around” the object associated with a poor quality metric if and/or until it is necessary to interact with the object. As another example, the mobile robot may be configured to grasp the object associated with the poor quality metric with the expectation that the object is likely to be dropped by the mobile robot. Performing such an action may enable the mobile robot to continue grasping other objects without having slow down its normal operation substantially while a user is instructed to perform a manual intervention with regard to the damaged object.

In some instances, a quality metric assigned to a first object in act 312 (e.g., a face of the first object) may indicate that first object has some damage (e.g., the object has a worn, bulging, or crushed face) but may still be capable of being effectively grasped and/or moved by the mobile robot. In such instances, the mobile robot may be configured to perform an action (e.g., selecting a particular grasping technique and/or strategy) in act 314 that takes in account the extent of damage to the first object as indicted by its assigned quality metric. For instance, if a first face (e.g., the front face of the object) is damaged, the mobile robot may be configured to grasp the object from a second face (e.g., the top face, a side face, etc.) different from the damaged face. In some instances, rather than selecting a different face to grasp, the mobile robot may be configured to grasp the face having damage, but in a manner that takes the damage into account. For example, when the mobile robot is configured to grasp objects using a suction gripper, suction cups in the vicinity of the damage may be turned off to improve the suction of other suction cups on the surface of the damaged face. As another example, the mobile robot may be configured to grasp the damaged face at a particular location based, at least in part, on the quality metric.

In some instances, the mobile robot may be controlled to select a grasping technique based on the quality metric assigned to the object. For example, when the mobile robot is configured to grasp objects using a suction gripper, selecting a grasping technique may include positioning the suction gripper and/or turning on different suction cups based on the quality metric assigned to the object. As another example, when the mobile robot is configured to grasp objects using one or more hand or claw grippers, selecting a grasping technique may include selecting a pinch grasp technique (e.g., using multiple members of a single hand/claw gripper or using a bimanual grasp), where the object is “pinched” between the different members of a single hand/claw gripper of between two hands/grippers, when the quality metric is less than a threshold value. It should be appreciated that selecting a pinch grasp technique is merely one example of a grasping technique that may be selected. For instance, when the quality metric assigned to an object indicates that one or more of the side faces of the object, the mobile robot may be configured to select a grasping technique that places at least one end effector under the object to better stabilize the object in the grasp. In some embodiments, controlling the mobile robot to perform an action may include determining the order of grasping objects from the set of objects based, at least in part, on the assigned quality metric. For example, as discussed in connection with an object having a poor quality, in some embodiments, the mobile robot may be configured to “pick around” a damaged object. By picking around a damaged object, faces of the object other than the damaged face may be revealed, and it may be possible to control the robot to securely grasp one of those faces to move the object.

In some embodiments, controlling the mobile robot to perform an action may include controlling the arm and/or gripper of the mobile robot after the object has been grasped in a manner that takes into consideration the quality metric assigned to the first object. For example, if the first object is worn or crushed, the mobile robot may be controlled to move the object slowly from a first location to a second location, move the object using a trajectory that reduces the risk of dropping the object (e.g., minimizing forces and/or accelerations applied to the object), rotating the object when grasped to reduce the risk of dropping the object, or any combination of the foregoing actions. In some embodiments, the dynamics and parametric shape of a trajectory through which the grasped object is moved may be determined based, at least in part, on the quality metric assigned to the first object. For example, the quality metric may be used to predict the sag experienced by the first object due to the damage, which may have implications for determining a trajectory that avoids collisions with the mobile robot and/or the environment. As another example, the quality metric may be used to determine the effects of trajectory dynamics on grasp quality to inform an upper bound on an acceptable wrench imparted on the first object.

In some embodiments, mass information associated with an object grasped by a mobile robot may be estimated, and changes in the estimated mass information may be used to determine when a grasped object has been dropped by the mobile robot. The inventors have recognized and appreciated that one cause of dropped objects may be due the grasped object being damaged and/or otherwise being of poor quality. Accordingly, some embodiments use information about changes in estimated mass information to identify images that may be used to train and/or retrain a machine learning model to determine a quality metric for one or more objects with which a mobile robot may interact.

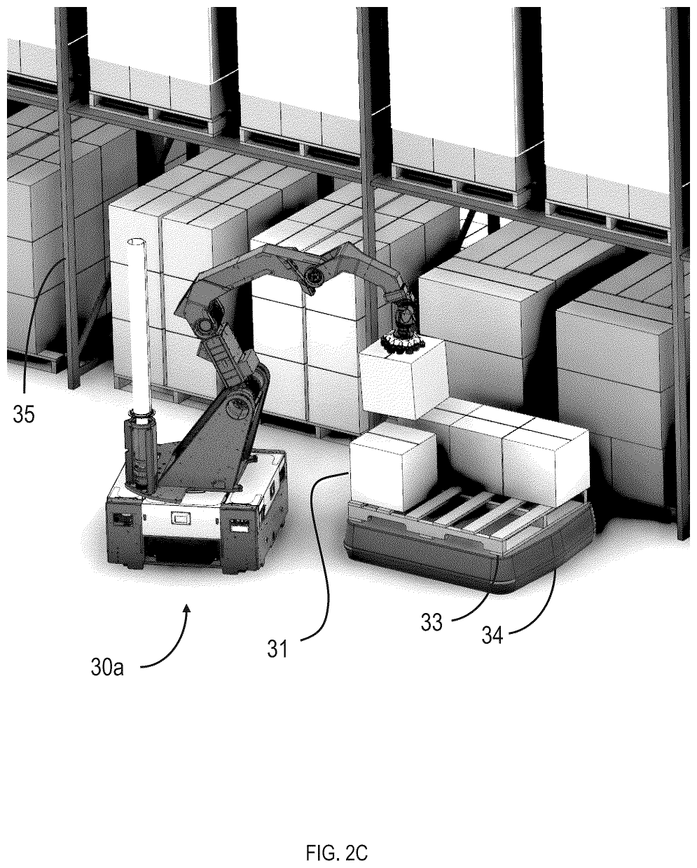

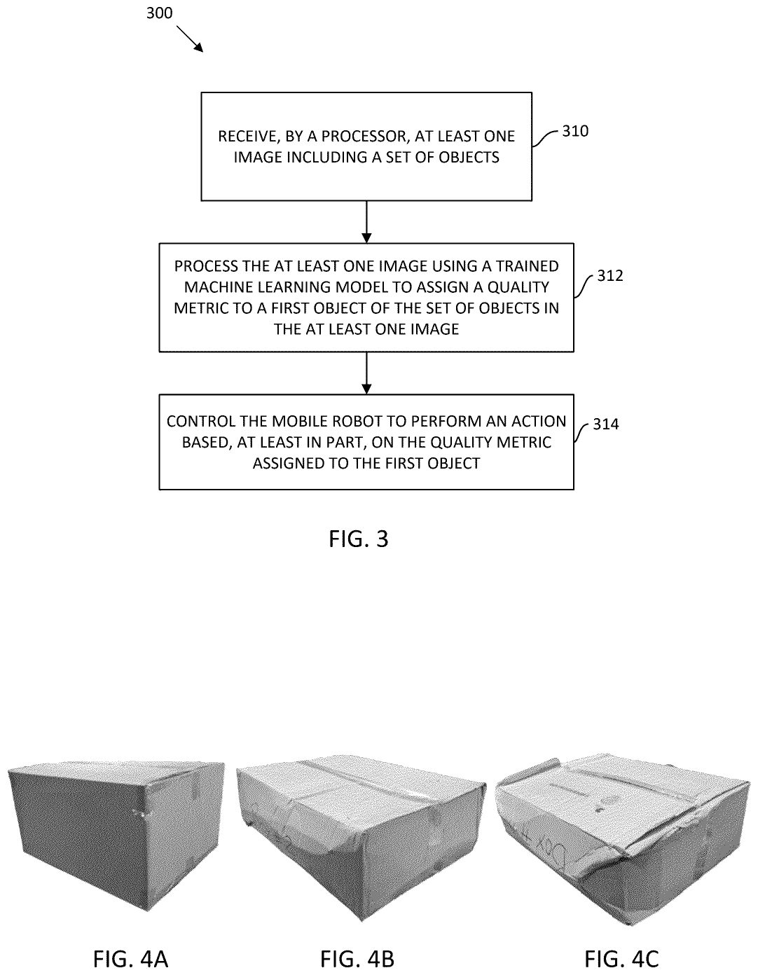

FIG. 5 illustrates a flowchart of a process 500 for training a machine learning model in accordance with some embodiments of the present disclosure. FIG. 5 begins in act 510, where the estimated mass of an object grasped by a mobile robot is determined (e.g., using one or more force sensors in the gripper of the mobile robot). For example, the mass of the grasped object may be continuously detected as the mobile robot is controlled to move the object from a first location (e.g., on a stack of objects) to a second location (e.g., on a conveyor). Process 500 then proceeds to act 512, where it is determined whether a change in the estimated mass of the grasped object has occurred. For example, when a change in the estimated mass of the grasped object exceeds a threshold value, it may be determined in act 512 that a change in the mass estimation of the grasped object has been detected. FIG. 6 shows an example plot of a mass estimate for a grasped object, in accordance with some embodiments of the present disclosure. As shown in FIG. 6, a sudden decrease in a monitored mass estimate for a grasped object may indicate that the mobile robot has dropped all or a portion of the grasped object. For instance, when the grasped object is a box, a sudden decrease in the mass estimate for the box may indicate that the box has broken open and its contents spilled on the floor.

When it is determined in act 512 that a change in mass estimation for the grasped object has not occurred, process 500 returns to act 510 where the estimated mass of the grasped object continues to be monitored. When it is determined in act 514 that a change in estimated mass of the grasped object has occurred, process 500 proceeds to act 514, where an image that includes the object prior to grasping by the mobile robot is selected. For example, when performing truck unloading, the mobile robot may be configured to capture a time sequence of images of a stack of boxes in a truck being unloaded from the stack onto a conveyor belt. A change in the estimated mass detected in act 512 may signify that a grasped box was dropped by the mobile device. In such an instance, an image of the stack of boxes immediately prior to the grasp may be selected for annotation by a human user. Upon receiving the image for annotation, the human user may annotate the image (e.g., by indicating the dropped box as being damaged). Process 500 then proceeds to act 516, where the annotated image is received by a processor associated with training the machine learning model. Process 500 then proceeds to act 518, where the annotated image is used to train the machine learning model. By monitoring the estimated mass of grasped objects and determining when changes to the estimated mass occurred, images that include damaged objects may be identified and sent for annotation, with the annotated images being used as training data for a machine learning model trained to output a quality metric for objects in an image.

The inventors have recognized and appreciated that it may be useful in some instances to track and generate a report of damaged objects identified when using a mobile robot to interact with objects. For example, when the mobile robot is instructed to perform a truck unload task that involves unloading boxes from a truck onto a conveyor, it may be useful to determine how many boxes in the truck were damaged prior to the robot interacting with the boxes. Such information may be provided, for example, to upstream providers of the boxes such as a manufacturing facility that packaged and/or handled the goods, the shipping company that delivered the goods to the warehouse, etc. Additionally or alternatively, information about damaged objects may be provided to one or more downstream operations in a warehouse to indicate that the damaged objects should be handled with care, repackaged, and/or discarded. For instance, information about damaged objects may be provided to a sortation system, which may use the information to divert damaged objects to a particular lane (e.g., a hospital lane).

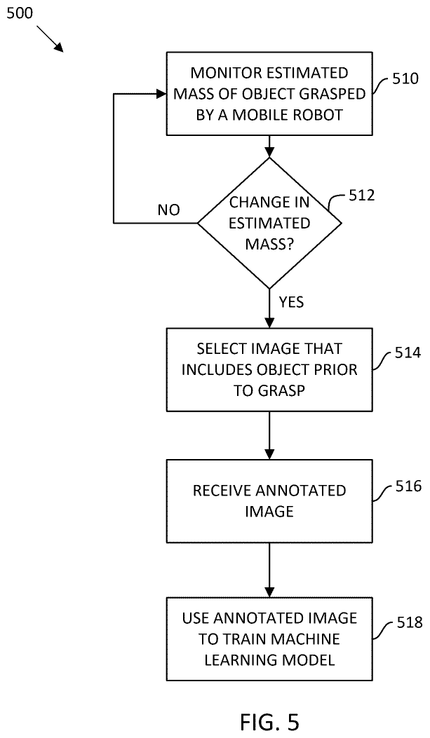

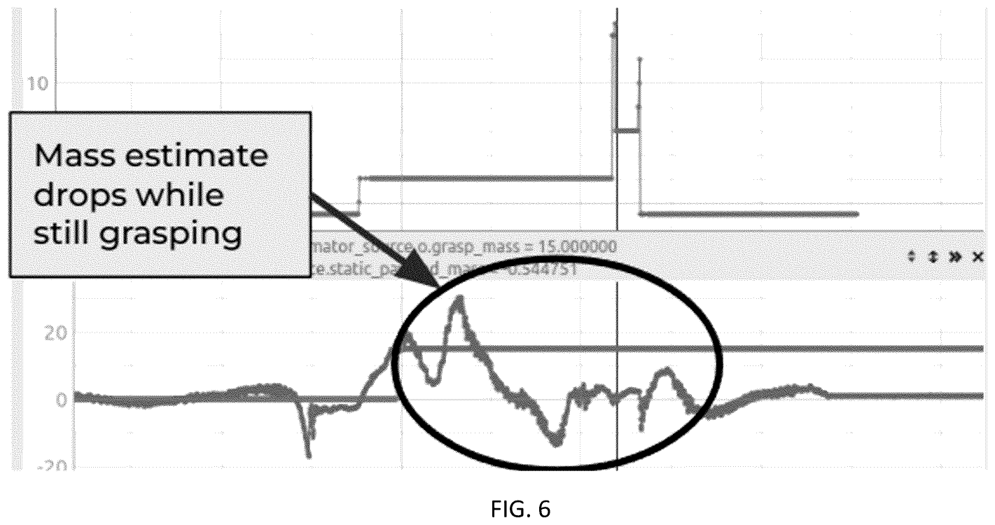

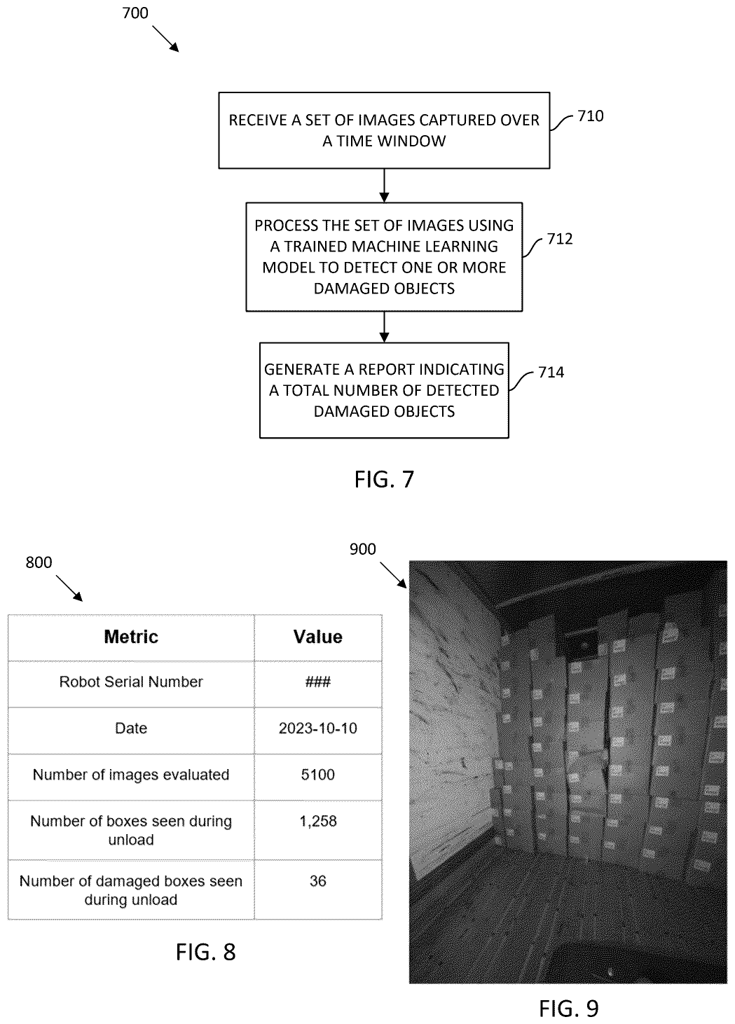

FIG. 7 is a flowchart of a process 700 for generating a report describing a number of detected damaged objects, in accordance with some embodiments of the present disclosure. Process 700 begins in act 710, where a set of images captured over a particular time window (e.g., one day) is received. Process 700 then proceeds to act 712, where the set of images is processed using a trained machine learning model to detect one or more damaged objects in the set of images. Process 700 then proceeds to act 714, where a report indicating a total number of damaged objects is generated based on the output of the trained machine learning model. FIG. 8 illustrates an example of a report 800 that may be generated in accordance with some embodiments. As shown, report 800 may include information identifying the mobile robot that captured the set of images, a date on which the set of images was captured, and information related to the total number of damaged objects identified using the trained machine learning model. In some embodiments, report 800 may include one or more images in which at least one damaged object was detected. FIG. 9 illustrates an example of an image 900 in which two damaged boxes were identified. Such an image 900 may be included in a report (e.g., report 800). In some embodiments, process 700 may be performed by one or more computer processors located “off-robot.” For instance, images captured by one or more sensors on-board the robot may be transferred to one or more computer processors separate from the robot for processing. In some embodiments, at least a portion of process 700 may be performed using computing resources located onboard the mobile robot.

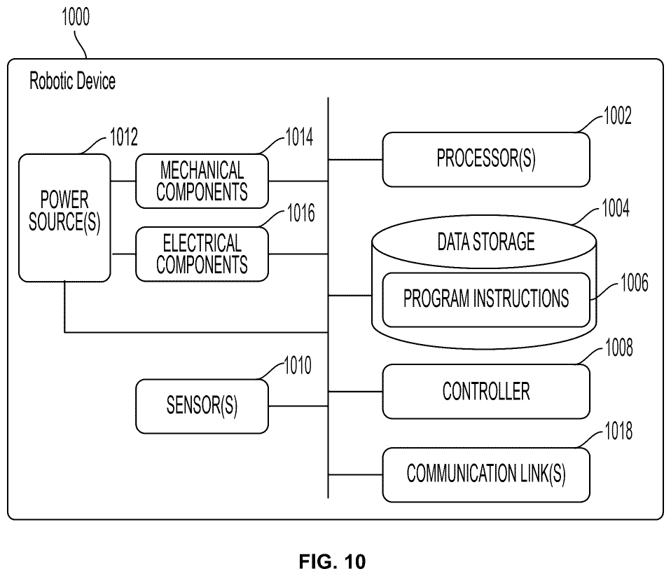

FIG. 10 illustrates an example configuration of a robotic device (or “robot”) 1000, according to an illustrative embodiment of the invention. The robotic device 1000 represents an example robotic device configured to perform the operations described herein. Additionally, the robotic device 1000 may be configured to operate autonomously, semi-autonomously, and/or using directions provided by user(s), and may exist in various forms, such as a humanoid robot, biped, quadruped, or other mobile robot, among other examples. Furthermore, the robotic device 1000 may also be referred to as a robotic system, mobile robot, or robot, among other designations.

As shown in FIG. 10, the robotic device 1000 includes processor(s) 1002, data storage 1004, program instructions 1006, controller 1008, sensor(s) 1010, power source(s) 1012, mechanical components 1014, and electrical components 1016. The robotic device 1000 is shown for illustration purposes and may include more or fewer components without departing from the scope of the disclosure herein. The various components of robotic device 1000 may be connected in any manner, including via electronic communication means, e.g., wired or wireless connections. Further, in some examples, components of the robotic device 1000 may be positioned on multiple distinct physical entities rather on a single physical entity. Other example illustrations of robotic device 1000 may exist as well.

Processor(s) 1002 may operate as one or more general-purpose processor or special purpose processors (e.g., digital signal processors, application specific integrated circuits, etc.). The processor(s) 1002 can be configured to execute computer-readable program instructions 1006 that are stored in the data storage 1004 and are executable to provide the operations of the robotic device 1000 described herein. For instance, the program instructions 1006 may be executable to provide operations of controller 1008, where the controller 1008 may be configured to cause activation and/or deactivation of the mechanical components 1014 and the electrical components 1016. The processor(s) 1002 may operate and enable the robotic device 1000 to perform various functions, including the functions described herein.

The data storage 1004 may exist as various types of storage media, such as a memory. For example, the data storage 1004 may include or take the form of one or more computer-readable storage media that can be read or accessed by processor(s) 1002. The one or more computer-readable storage media can include volatile and/or non-volatile storage components, such as optical, magnetic, organic or other memory or disc storage, which can be integrated in whole or in part with processor(s) 1002. In some implementations, the data storage 1004 can be implemented using a single physical device (e.g., one optical, magnetic, organic or other memory or disc storage unit), while in other implementations, the data storage 1004 can be implemented using two or more physical devices, which may communicate electronically (e.g., via wired or wireless communication). Further, in addition to the computer-readable program instructions 1006, the data storage 1004 may include additional data such as diagnostic data, among other possibilities.

The robotic device 1000 may include at least one controller 1008, which may interface with the robotic device 1000. The controller 1008 may serve as a link between portions of the robotic device 1000, such as a link between mechanical components 1014 and/or electrical components 1016. In some instances, the controller 1008 may serve as an interface between the robotic device 1000 and another computing device. Furthermore, the controller 1008 may serve as an interface between the robotic device 1000 and a user(s). The controller 1008 may include various components for communicating with the robotic device 1000, including one or more joysticks or buttons, among other features. The controller 1008 may perform other operations for the robotic device 1000 as well. Other examples of controllers may exist as well.

Additionally, the robotic device 1000 includes one or more sensor(s) 1010 such as force sensors, proximity sensors, motion sensors, load sensors, position sensors, touch sensors, depth sensors, ultrasonic range sensors, and/or infrared sensors, among other possibilities. The sensor(s) 1010 may provide sensor data to the processor(s) 1002 to allow for appropriate interaction of the robotic device 1000 with the environment as well as monitoring of operation of the systems of the robotic device 1000. The sensor data may be used in evaluation of various factors for activation and deactivation of mechanical components 1014 and electrical components 1016 by controller 1008 and/or a computing system of the robotic device 1000.

The sensor(s) 1010 may provide information indicative of the environment of the robotic device for the controller 1008 and/or computing system to use to determine operations for the robotic device 1000. For example, the sensor(s) 1010 may capture data corresponding to the terrain of the environment or location of nearby objects, which may assist with environment recognition and navigation, etc. In an example configuration, the robotic device 1000 may include a sensor system that may include a camera, RADAR, LIDAR, time-of-flight camera, global positioning system (GPS) transceiver, and/or other sensors for capturing information of the environment of the robotic device 1000. The sensor(s) 1010 may monitor the environment in real-time and detect obstacles, elements of the terrain, weather conditions, temperature, and/or other parameters of the environment for the robotic device 1000.

Further, the robotic device 1000 may include other sensor(s) 1010 configured to receive information indicative of the state of the robotic device 1000, including sensor(s) 1010 that may monitor the state of the various components of the robotic device 1000. The sensor(s) 1010 may measure activity of systems of the robotic device 1000 and receive information based on the operation of the various features of the robotic device 1000, such the operation of extendable legs, arms, or other mechanical and/or electrical features of the robotic device 1000. The sensor data provided by the sensors may enable the computing system of the robotic device 1000 to determine errors in operation as well as monitor overall functioning of components of the robotic device 1000.

For example, the computing system may use sensor data to determine the stability of the robotic device 1000 during operations as well as measurements related to power levels, communication activities, components that require repair, among other information. As an example configuration, the robotic device 1000 may include gyroscope(s), accelerometer(s), and/or other possible sensors to provide sensor data relating to the state of operation of the robotic device. Further, sensor(s) 1010 may also monitor the current state of a function that the robotic device 1000 may currently be operating. Additionally, the sensor(s) 1010 may measure a distance between a given robotic limb of a robotic device and a center of mass of the robotic device. Other example uses for the sensor(s) 1010 may exist as well.

Additionally, the robotic device 1000 may also include one or more power source(s) 1012 configured to supply power to various components of the robotic device 1000. Among possible power systems, the robotic device 1000 may include a hydraulic system, electrical system, batteries, and/or other types of power systems. As an example illustration, the robotic device 1000 may include one or more batteries configured to provide power to components via a wired and/or wireless connection. Within examples, components of the mechanical components 1014 and electrical components 1016 may each connect to a different power source or may be powered by the same power source. Components of the robotic device 1000 may connect to multiple power sources as well.

Within example configurations, any type of power source may be used to power the robotic device 1000, such as a gasoline and/or electric engine. Further, the power source(s) 1012 may charge using various types of charging, such as wired connections to an outside power source, wireless charging, combustion, or other examples. Other configurations may also be possible. Additionally, the robotic device 1000 may include a hydraulic system configured to provide power to the mechanical components 1014 using fluid power. Components of the robotic device 1000 may operate based on hydraulic fluid being transmitted throughout the hydraulic system to various hydraulic motors and hydraulic cylinders, for example. The hydraulic system of the robotic device 1000 may transfer a large amount of power through small tubes, flexible hoses, or other links between components of the robotic device 1000. Other power sources may be included within the robotic device 1000.

Mechanical components 1014 can represent hardware of the robotic device 1000 that may enable the robotic device 1000 to operate and perform physical functions. As a few examples, the robotic device 1000 may include actuator(s), extendable leg(s), arm(s), wheel(s), one or multiple structured bodies for housing the computing system or other components, and/or other mechanical components. The mechanical components 1014 may depend on the design of the robotic device 1000 and may also be based on the functions and/or tasks the robotic device 1000 may be configured to perform. As such, depending on the operation and functions of the robotic device 1000, different mechanical components 1014 may be available for the robotic device 1000 to utilize. In some examples, the robotic device 1000 may be configured to add and/or remove mechanical components 1014, which may involve assistance from a user and/or other robotic device.

The electrical components 1016 may include various components capable of processing, transferring, providing electrical charge or electric signals, for example. Among possible examples, the electrical components 1016 may include electrical wires, circuitry, and/or wireless communication transmitters and receivers to enable operations of the robotic device 1000. The electrical components 1016 may interwork with the mechanical components 1014 to enable the robotic device 1000 to perform various operations. The electrical components 1016 may be configured to provide power from the power source(s) 1012 to the various mechanical components 1014, for example. Further, the robotic device 1000 may include electric motors. Other examples of electrical components 1016 may exist as well.

In some implementations, the robotic device 1000 may also include communication link(s) 1018 configured to send and/or receive information. The communication link(s) 1018 may transmit data indicating the state of the various components of the robotic device 1000. For example, information read in by sensor(s) 1010 may be transmitted via the communication link(s) 1018 to a separate device. Other diagnostic information indicating the integrity or health of the power source(s) 1012, mechanical components 1014, electrical components 1016, processor(s) 1002, data storage 1004, and/or controller 1008 may be transmitted via the communication link(s) 1018 to an external communication device.

In some implementations, the robotic device 1000 may receive information at the communication link(s) 1018 that is processed by the processor(s) 1002. The received information may indicate data that is accessible by the processor(s) 1002 during execution of the program instructions 1006, for example. Further, the received information may change aspects of the controller 1008 that may affect the behavior of the mechanical components 1014 or the electrical components 1016. In some cases, the received information indicates a query requesting a particular piece of information (e.g., the operational state of one or more of the components of the robotic device 1000), and the processor(s) 1002 may subsequently transmit that particular piece of information back out the communication link(s) 1018.

In some cases, the communication link(s) 1018 include a wired connection. The robotic device 1000 may include one or more ports to interface the communication link(s) 1018 to an external device. The communication link(s) 1018 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

A number of implementations have been described. Nevertheless, it will be understood that various modifications may be made without departing from the spirit and scope of the disclosure.

1. A method comprising:
receiving, by a processor of a mobile robot, at least one image including a set of objects;
processing the at least one image using a trained machine learning model to assign a quality metric to a first object of the set of objects in the at least one image; and
controlling the mobile robot to perform an action based, at least in part, on the quality metric assigned to the first object.

2. The method of claim 1, wherein
the set of objects includes a set of boxes,
the trained machine learning model includes a box detection model, and
processing the at least one image to assign a quality metric to a first object of the set of objects comprises processing the at least one image using the box detection model.

3. The method of claim 2, wherein the box detection model is configured to detect two dimensional box faces or three dimensional shapes.

4. The method of claim 1, wherein processing the at least one image to assign a quality metric to a first object of the set of objects comprises:
determining an extent of damage to the first object; and
assigning the quality metric based on the extent of damage to the first object.

5. The method of claim 4, wherein determining an extent of damage to the first object comprises categorizing the extent of damage into two or more categories of damage.

6. The method of claim 1, wherein controlling the mobile robot to perform an action comprises:
controlling the mobile robot to provide an indication to a user that the first object cannot be effectively grasped by the mobile robot when the quality metric is less than a threshold value.

7. The method of claim 1, wherein controlling the mobile robot to perform an action comprises:
selecting, based on the quality metric associated with the first object, a grasping strategy for grasping the first object; and
controlling the mobile robot to grasp the first object based on the grasping strategy.

8. The method of claim 7, wherein
selecting a grasping strategy for grasping the first object comprises selecting a second face of the first object to grasp when the quality metric assigned to the first object indicates that a first face of the first object has a quality less than a threshold value, and
controlling the mobile robot to grasp the first object based on the grasping strategy comprises controlling the mobile robot to grasp the second face of the first object.

9. The method of claim 7, wherein
selecting a grasping strategy for grasping the first object comprises selecting one or more locations on the first object to grasp the first object, and
controlling the mobile robot to grasp the first object based on the grasping strategy comprises controlling the mobile robot to grasp the first object at the one or more locations.

10. The method of claim 7, wherein
selecting a grasping strategy for grasping the first object comprises selecting a grasping technique based on the quality metric assigned to the first object, and
controlling the mobile robot to grasp the first object based on the grasping strategy comprises controlling the mobile robot to grasp the first object using the grasping technique.

11. The method of claim 10, wherein selecting the grasping technique comprises selecting a pinch grasp technique when the quality metric assigned to the first object is less than a threshold value.

12. The method of claim 1, wherein controlling the mobile robot to perform an action comprises determining an order of grasping objects from the set of objects based, at least in part, on the quality metric.

13. The method of claim 12, wherein determining an order of grasping objects from the set of objects comprises determining to grasp a second object of the set of objects prior to grasping the first object when the quality metric assigned to the first object is less than a threshold value.

14. The method of claim 12, wherein determining an order of grasping objects from the set of objects comprises determining to grasp the first object first when the quality metric assigned to the first object is less than a threshold value.

15. The method of claim 1, wherein controlling the mobile robot to perform an action comprises controlling the mobile robot to move the first object from a first location to a second location at a speed determined based, at least in part, on the quality metric.

16. The method of claim 1, wherein controlling the mobile robot to perform an action comprises controlling the mobile robot to move the first object from a first location to a second location through a trajectory determined based, at least in part, on the quality metric.

17. The method of claim 16, further comprising:
determining, a parametric shape and dynamics of the trajectory based, at least part, on the quality metric.

18. The method of claim 1, wherein
controlling the mobile robot to perform an action comprises controlling the mobile robot to grasp the first object, and
the method further comprises:
detecting a change in an estimated mass of the first object while grasping the first object;
selecting an image including the first object captured prior to grasping the first object;
receiving an annotated version of the image; and
retraining the trained machine learning model using the annotated version of the image.

19. A mobile robot, comprising:
a processor configured to:
receive at least one image including a set of objects; and
process the at least one image using a trained machine learning model to assign a quality metric to a first object of the set of objects in the at least one image; and
a controller configured to control the mobile robot to perform an action based, at least in part, on the quality metric assigned to the first object.

20. A non-transitory computer readable medium including a plurality of processor executable instructions stored thereon that, when executed by a processor, perform a method of:
receiving at least one image including a set of objects;
processing the at least one image using a trained machine learning model to assign a quality metric to a first object of the set of objects in the at least one image; and
controlling a mobile robot to perform an action based, at least in part, on the quality metric assigned to the first object.
